(19) United States
(12) Patent Application Publication
(10) Pub. No.: US 2023/0387551 A1
(43) Pub. Date: Nov. 30, 2023

(54) AIR ELECTRODE/SEPARATOR ASSEMBLY AND METAL-AIR SECONDARY BATTERY

(71) Applicant: NGK INSULATORS, LTD., Nagoya-City (JP)

(72) Inventors: Naomi HASHIMOTO, Nagoya-City (JP); Ozora KANO, Nagoya-City (JP); Yukari SAKURAYAMA, Nagoya-City (JP); Naomi SAITO, Nagoya-City (JP)

(73) Assignee: NGK INSULATORS, LTD., Nagoya-City (JP)

(21) Appl. No.: 18/449,019

(22) Filed: Aug. 14, 2023

Related U.S. Application Data
(63) Continuation of application No. PCT/JP2021/044332, filed on Dec. 2, 2021.

(30) Foreign Application Priority Data
Mar. 30, 2021 (JP) 2021-058867

(51) Int. Cl. H01M 50/451; H01M 12/08; H01M 50/497

(52) U.S. Cl. CPC H01M 50/451; H01M 12/08; H01M 50/497

(57) ABSTRACT

Provided is an air electrode/separator assembly including a hydroxide ion conductive separator, a catalyst layer including a catalyst for an air electrode, a hydroxide ion conductive material, an electron conductive material, a binder, and a humidity conditioning material and covering one side of the hydroxide ion conductive separator, and a gas diffusion electrode provided on the catalyst layer on a side opposite to the hydroxide ion conductive separator.

### CROSS-REFERENCE TO RELATED APPLICATIONS

This application is a continuation application of PCT/JP2021/044332 filed Dec. 2, 2021, which claims priority to Japanese Patent Application No. 2021-058867 filed Mar. 30, 2021, the entire contents all of which are incorporated herein by reference.

### BACKGROUND OF THE INVENTION

### 1. Field of the Invention

The present disclosure relates to an air electrode/separator assembly and metal-air secondary battery.

### 2. Description of the Related Art

One of the innovative battery candidates is a metal-air secondary battery. In the metal-air secondary battery, oxygen as a positive electrode active material is supplied from the air, and the space inside the battery container can thus be utilized to the maximum extent for filling the negative electrode active material, whereby in principle a high energy density is realized. For example, in a zinc-air secondary battery, in which zinc is used as a negative electrode active material, an alkaline aqueous solution such as potassium hydroxide is used as an electrolyte, and a separator (partition membrane) is used to prevent a short circuit between positive and negative electrodes. Upon discharge, O₂ is reduced on an air electrode (positive electrode) side to generate OH⁻, while zinc is oxidized on a negative electrode to generate ZnO, as shown in the following reaction formulas.

Positive electrode: O₂+2H₂O+4e⁻→4OH⁻

Negative electrode: 2Zn+4OH⁻→2ZnO+2H₂O+4e⁻

By the way, it is known that in zinc secondary batteries such as a zinc-air secondary battery and nickel-zinc secondary battery, metallic zinc in a dendrite form precipitates from a negative electrode upon charge, penetrates voids of a separator such as a nonwoven fabric, and reaches a positive electrode, resulting in occurrence of a short circuit. This short circuit due to such zinc dendrites leads to shorten repeated charge/discharge life. Moreover, another problem with the zinc-air secondary battery is that carbon dioxide in the air passes through the air electrode, dissolves in the electrolyte, and precipitates an alkali carbonate to deteriorate the battery performance. Similar problems as described above can occur with lithium-air secondary batteries.

In order to deal with the problems described above, a battery comprising a layered double hydroxide (LDH) separator that blocks the penetration of zinc dendrite while selectively permeating hydroxide ions has been proposed. For example, Patent Literature 1 (WO2013/073292) discloses a zinc-air secondary battery including a LDH separator provided between an air electrode and a negative electrode in order to prevent both the short circuit between the positive and negative electrodes due to zinc dendrite and the inclusion of carbon dioxide. Patent Literature 2 (WO2016/076047) discloses a separator structure comprising an LDH separator fitted or joined to a resin outer frame, wherein the LDH separator has a high denseness such that it has a gas impermeability and/or water impermeability. Moreover, the literature also discloses that the LDH separator can be composited with a porous substrate. Further, Patent Literature 3 (WO2016/067884) discloses various methods for forming an LDH dense membrane on a surface of a porous substrate to obtain a composite material (LDH separator). This method comprises steps of uniformly adhering a starting material that can impart a starting point for LDH crystal growth to the porous substrate, treating hydrothermally the porous substrate in a raw material aqueous solution to form an LDH dense membrane on a surface of the porous substrate. Moreover, LDH-like compounds have being known as hydroxides and/or oxides with a layered crystal structure that cannot be called LDH but are analogous thereto, which exhibit hydroxide ion conductive properties similar to those of LDH to an extent that it can be collectively referred to as hydroxide ion conductive layered compounds together with LDH. For example, Patent Literature (WO2020/255856) discloses a hydroxide ion conductive separator containing a porous substrate and a layered double hydroxide (LDH)-like compound that clogs up pores in the porous substrate.

Moreover, in a field of metal-air secondary batteries such as a zinc-air secondary battery, an air electrode/separator assembly in which an air electrode layer is provided on an LDH separator has been proposed. Patent Literature 5 (WO2015/146671) discloses an air electrode/separator assembly comprising an LDH separator and an air electrode layer thereon, the air electrode layer containing an air electrode catalyst, an electron conductive material, and a hydroxide ion conductive material. Further, Patent Literature 6 (WO2018/163353) discloses a method for producing an air electrode/separator assembly by directly joining an air electrode layer containing LDH and carbon nanotubes (CNT) on an LDH separator.

Further, proposals have been made in the field of metal-air secondary batteries, such as zinc-air secondary batteries, to divide a catalyst layer of an air electrode into two layers. For example, Patent Literature 7 (JP2016-81572A) discloses a catalyst layer for charge having hydrophilicity that is provided on an air electrode on a side of an electrolyte, and a catalyst layer for discharge having hydrophobicity that is provided on the air electrode on a side opposite to the electrolyte.

### CITATION LIST

### Patent Literature

Patent Literature 1: WO2013/073292
Patent Literature 2: WO2016/076047
Patent Literature 3: WO2016/067884
Patent Literature 4: WO2020/255856
Patent Literature 5: WO2015/146671
Patent Literature 6: WO2018/163353
Patent Literature 7: JP2016-81572A

### SUMMARY OF THE INVENTION

As described above, the metal-air secondary battery including an LDH separator has an excellent advantage of preventing both a short circuit between the positive and negative electrodes due to the metal dendrite and an inclusion of carbon dioxide. Further, it also has an advantage of being capable of inhibiting evaporation of water contained in the electrolyte due to the denseness of the LDH separator. Due to the denseness of the LDH separator, on the other hand, water accumulates in pores of a catalyst layer (water produced in a reaction cannot be drained), and oxygen necessary for a reaction cannot have access to a catalyst surface, leading to a decrease in discharge performance. Thus, there is a need for an air electrode/separator assembly that exhibits excellent charge/discharge characteristics while having the advantages of using an LDH separator.

The present inventors have now found that a battery when used as a metal-air secondary battery exhibits excellent charge/discharge characteristics by forming a catalyst layer including a humidity conditioning material on a hydroxide ion conductive separator, such as an LDH separator.

Therefore, an object of the present invention is to provide an air electrode/separator assembly that exhibits excellent charge/discharge performance when used in a metal-air secondary battery while including a hydroxide ion conduction separator such as an LDH separator.

According to an aspect of the present invention, there is provided an air electrode/separator assembly, comprising:
a hydroxide ion conductive separator,
a catalyst layer comprising a catalyst for an air electrode, a hydroxide ion conductive material, an electron conductive material, a binder, and a humidity conditioning material and covering one side of the hydroxide ion conductive separator, and
a gas diffusion electrode provided on the catalyst layer on a side opposite to the hydroxide ion conductive separator.

According to a preferred aspect of the present invention, the air electrode/separator assembly further comprises a humidity conditioning portion at an outer circumferential portion of the catalyst layer, the humidity conditioning portion comprising a humidity conditioning material. By forming the humidity conditioning portion at the outer circumferential portion of the electrode in this manner, the battery can exhibit superior charge/discharge performance when used in a metal-air secondary battery.

According to a preferred aspect of the present invention, the air electrode/separator assembly is arranged vertically, and the humidity conditioning portion is provided at an outer circumferential portion of the catalyst layer other than the top edge thereof.

Alternatively, according to another preferred aspect of the present invention, the air electrode/separator assembly is arranged horizontally, and the humidity conditioning portion is provided over an entire circumferential portion of the catalyst layer.

According to a preferred aspect of the present invention, the humidity conditioning material comprises a water absorbent resin. Preferably, the humidity conditioning material further comprises a silica gel. The water absorbent resin is preferred to be at least one selected from the group consisting of a polyacrylamide resin, potassium polyacrylate, a polyvinyl alcohol resin, and a cellulose resin.

According to a preferred aspect of the present invention, the catalyst layer comprises 0.001 to 15% by volume of the humidity conditioning material in terms of solid content, relative to 100% by volume of solid content of the catalyst layer.

According to a preferred aspect of the present invention, the catalyst layer comprises a two-layer structure composed of a catalyst layer for charge adjacent to the hydroxide ion conductive separator and a catalyst layer for discharge adjacent to the gas diffusion electrode. In this manner, by forming, on the separator, the catalyst layer divided into two layers, one for charging and the other for discharging, and by adding the hydroxide ion conductive material to the catalyst layer for discharging, the discharge performance can be particularly improved.

According to a preferred aspect of the present invention, the hydroxide ion conductive separator is a layered double hydroxide (LDH) separator.

According to a preferred aspect of the present invention, the catalyst layer comprises 10 to 60% by volume of the hydroxide ion conductive material relative to 100% by volume of solid content of the catalyst layer.

According to a preferred aspect of the present invention, the hydroxide ion conductive separator is a layered double hydroxide (LDH) separator. Preferably, the LDH separator is composited with a porous substrate.

According to a preferred aspect of the present invention, the air electrode/separator assembly further comprises an air electrode current collector on the gas diffusion electrode on a side opposite to the catalyst layer.

According to another aspect of the present invention, there is provided a metal-air secondary battery comprising the air electrode/separator assembly, a metal negative electrode, and an electrolyte, wherein the electrolyte is separated from the catalyst layer by the hydroxide ion conductive separator interposed therebetween.

### BRIEF DESCRIPTION OF THE DRAWINGS

FIG. 1A is a plan view schematically illustrating one example of the air electrode/separator assembly according to the present invention, corresponding to the air electrode/separator assembly fabricated in Example 1.

FIG. 1B is a side view of the air electrode/separator assembly shown in FIG. 1A.

FIG. 1C is a cross-sectional view of the air electrode/separator assembly shown in FIG. 1A.

FIG. 2A is a plan view schematically illustrating another aspect of the air electrode/separator assembly according to the present invention, corresponding to the air electrode/separator assembly fabricated in Example 2.

FIG. 2B is a side view of the air electrode/separator assembly shown in FIG. 2A.

FIG. 3A is a plan view schematically illustrating one example of the air electrode/separator assembly according to the present invention arranged horizontally.

FIG. 3B is a side view of the air electrode/separator assembly shown in FIG. 3A.

FIG. 3C is a cross-sectional view of the air electrode/separator assembly shown in FIG. 3A.

FIG. 4 is a schematic cross-sectional view conceptually illustrating an LDH separator used in the present invention.

FIG. 5A is a conceptual view of an example of the He permeability measurement system used in Example 1.

FIG. 5B is a schematic cross-sectional view of a sample holder used in the measurement system shown in FIG. 5A and peripheral configuration thereof.

FIG. 6 is an SEM image when observing a surface of the LDH separator fabricated in Example 1.

FIG. 7 is a graph illustrating cycle characteristics measured for the zinc-air secondary batteries fabricated in Examples 1 to 3.

### DETAILED DESCRIPTION OF THE INVENTION

Air Electrode/Separator Assembly

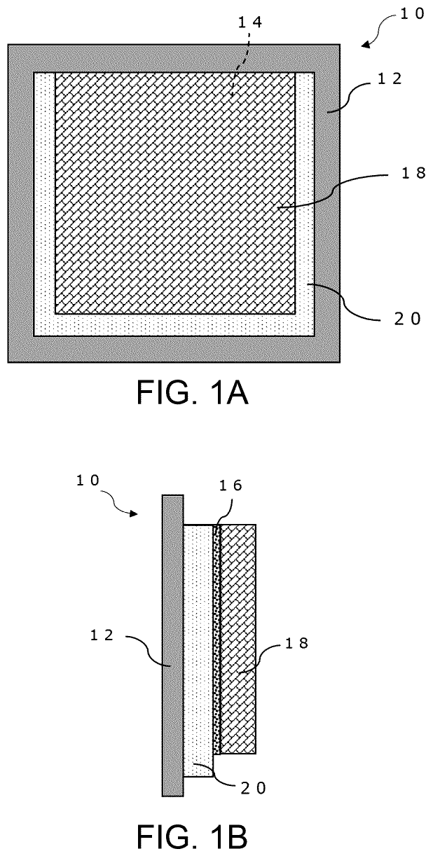

FIGS. 1A to 1C show one aspect of an air electrode/separator assembly using a layered double hydroxide (LDH) separator as a hydroxide ion conductive dense separator. The contents hereinafter described for the LDH separator will also apply to a hydroxide ion conductive dense separator other than the LDH separator, as long as the technical consistency is not lost. Namely, the LDH separator is hereinafter interchangeable with a hydroxide ion conductive dense separator, as long as the technical consistency is not lost.

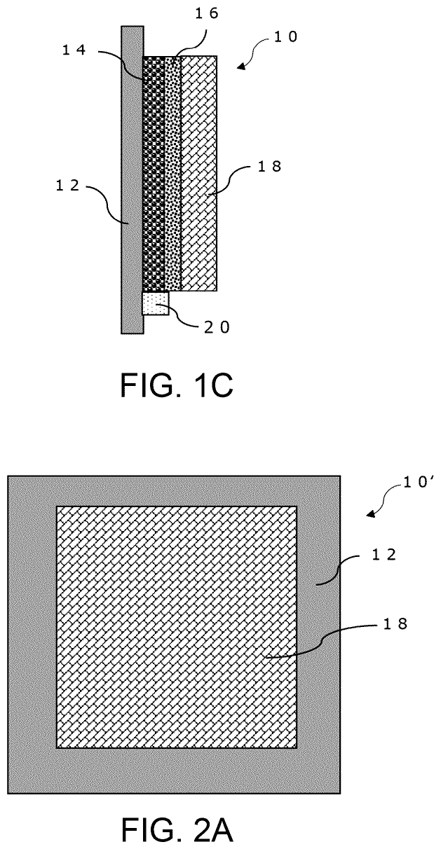

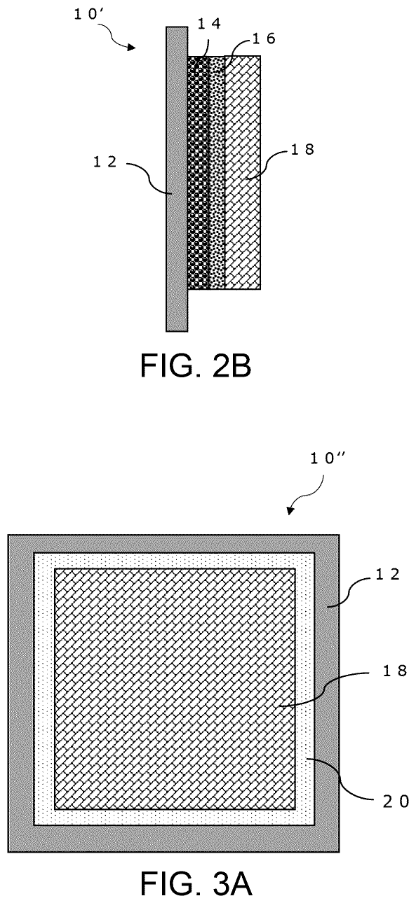

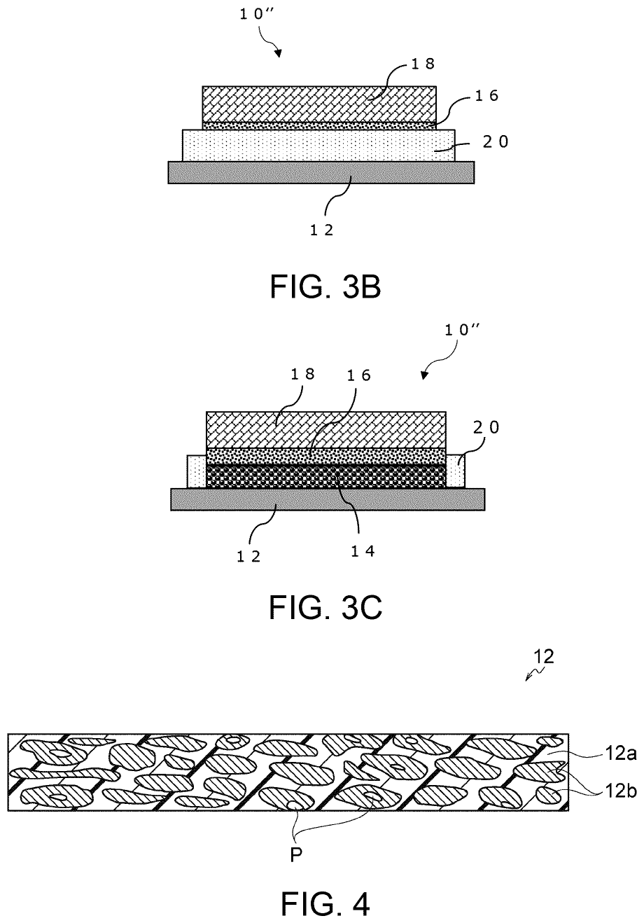

An air electrode/separator assembly 10 shown in FIGS. 1A to 1C each comprises a layered double hydroxide (LDH) separator 12, a catalyst layer 14, a gas diffusion electrode 16, and an air electrode current collector 18. Air electrode/separator assembly 10 also preferably has a humidity conditioning portion 20 at an outer circumferential portion excluding the upper portion of catalyst layer 14; however, it does not necessarily have humidity conditioning portion 20, as in an air electrode/separator assembly 10′ shown in FIGS. 2A and 2B. Alternatively, it may be arranged horizontally, as in air electrode/separator assembly 10″ shown in FIGS. 3A to 3C, in which case humidity conditioning portion 20 is preferably provided over the entire outer circumferential portion of catalyst layer 14. Catalyst layer 14 is a layer covering one side of LDH separator 12, and contains a hydroxide ion conductive material, electron conductive material, catalyst, binder, and humidity conditioning material. Gas diffusion electrode 16 is a layer provided on catalyst layer 14, and air electrode current collector 18 is further provided thereon. Containing the humidity conditioning material or humidity conditioning portion in catalyst layer 14 and at the outer circumferential portion thereof in such a way enables adjustment of moisture of water produced in a reaction and exhibition of excellent charge/discharge characteristics when used for a metal-air secondary battery.

Namely, as described above, the metal-air secondary battery including an LDH separator has an excellent advantage of preventing both a short circuit between the positive and negative electrodes due to metal dendrite and inclusion of carbon dioxide. Further, it also has an advantage of being capable of inhibiting evaporation of water contained in the electrolyte due to the denseness of the LDH separator. Due to the denseness of the LDH separator, on the other hand, water produced in the reaction cannot be drained and accumulates in pores of a catalyst layer, and oxygen necessary for the reaction cannot have access to a catalyst surface, leading to a decrease in discharge performance. In this respect, such a problem is conveniently solved according to air electrode/separator assembly 10.

The details of the mechanism are not necessarily clear, but it is surmised as follows. Namely, since the humidity conditioning material that allows absorption and release of moisture is present in catalyst layer 14, the humidity conditioning material can absorb water produced in a reaction and conversely release it when necessary for the reaction, thus allowing a reaction field suitable for charging and discharging reactions to be formed. Moreover, when catalyst layer 14 is divided into a catalyst layer for charge and a catalyst layer for discharge, the catalyst layer for charge is formed to be hydrophilic and the catalyst layer for discharge is formed to be hydrophobic so that environments thereof are suitable for each reaction, however, in the case of using a porous separator, if the catalyst layer for discharge is brought into a hydrophobic environment, an electrolyte does not penetrate into the catalyst layer for discharge, and a discharging reaction occurs only at the interface between the catalyst layer for charge and the catalyst layer for discharge. By using the hydroxide ion conductive dense separator and arranging the hydroxide ion conductive material so that ion conductive paths are formed in the entire catalyst layer, the reaction can proceed throughout the catalyst layer for discharge.

LDH Separator

LDH separator is a separator containing a layered double hydroxide (LDH) and/or an LDH-like compound (hereinafter collectively referred to as a hydroxide ion conductive layered compound) and is defined as a separator that selectively passes hydroxide ions by solely utilizing hydroxide ion conductivity of the hydroxide ion conductive layered compound. The “LDH-like compound” herein is a hydroxide and/or oxide having a layered crystal structure analogous to LDH but is a compound that may not be called LDH, and it can be said to be an equivalent of LDH. However, according to a broad sense of definition, it can be appreciated that “LDH” encompasses not only LDH but also LDH-like compounds. Such LDH separators can be those known as disclosed in Patent literatures 1 to 6 and are preferably LDH separators composited with porous substrates.

A particularly preferable LDH separator 12 contains a porous substrate 12a made of a polymer material and a hydroxide ion conductive layered compound 12b that clogs up pores P of the porous substrate, as conceptually shown in FIG. 4, and LDH separator 12 of this type will be described later. The porous substrate 12a containing a polymer material can be bent even when pressurized and hardly cracks, which is extremely advantageous when battery components including the substrate and other components (negative electrode plate, etc.) that are housed in a battery case are pressurized in the direction such that each battery components are adhered to one another. Since LDH separator 12 including porous substrate 12a made of polymer material can also be flexible and thermally weldable, it can be folded or two or more sheets can be stacked and thermally welded and sealed. In any case, adoption of the above configuration reliably enables separation of the compartment including the air electrode layer (catalyst layer and gas diffusion electrode) and the compartment including the negative electrode plate via LDH separator 12 so that hydroxide ion are selectively passed while gas impermeability and water impermeability being secured.

However, in the present invention, various hydroxide ion conductive dense separators can be used instead of LDH separator 12. The hydroxide ion conductive dense separator is a separator containing the hydroxide ion conductive material and is defined as a separator that selectively passes hydroxide ions by solely utilizing the hydroxide ion conductivity of the hydroxide ion conductive material. Therefore, the hydroxide ion conductive dense separator has gas impermeability and/or water impermeability, particularly gas impermeability. Namely, the hydroxide ion conductive material constitutes all or a part of the hydroxide ion conductive dense separator having high denseness such that it exhibits gas impermeability and/or water impermeability. Definitions of gas impermeability and/or water impermeability will be described later with respect to LDH separator 12. The hydroxide ion conductive dense separator may be composited with a porous substrate.

Catalyst Layer

Catalyst layer 14 contains a catalyst for an air electrode (for example, a catalyst for charge and catalyst for discharge), hydroxide ion conductive material, electron conductive material, moisture conditioning material, and binder. The catalyst in catalyst layer 14 has a spherical, platy, or fibrous form and is dispersed in the catalyst layer. The catalyst for an air electrode may be separately used for a catalyst for charge and that for discharge, or a single catalyst may be responsible for each of charging and discharging reactions. The catalyst may also serve both as an electron conductive material and a hydroxide ion conductive material. The catalyst is not particularly limited as long as it has catalytic activity for each reaction, but the catalyst for discharge is preferably a carbon-based catalyst, oxide catalyst, or metal catalyst, while the catalyst for charge is preferably a hydroxide catalyst, oxide catalyst, or carbon-based catalyst. The catalyst is desirably in a form of fine particles in order to increase a reaction field. Specifically, a particle size of the catalyst contained in catalyst layer 14 is preferably 5 μm or less, more preferably 0.5 nm to 3 μm, and still more preferably 1 nm to 3 μm.

The hydroxide ion conductive material contained in catalyst layer 14 has a spherical, platy, or beltlike form and forms a conductive path in the entire catalyst layer. The hydroxide ion conductive material is not particularly limited as long as it has hydroxide ion conductivity and is preferably an LDH. The composition of LDH is not particularly limited, and preferably has a basic composition represented by the formula: M²⁺₁₋ₓM³⁺ₓ(OH)₂Aⁿ⁻_{x/n}·mH₂O, wherein M²⁺ is at least one divalent cation, M³⁺ is at least one trivalent cation, Aⁿ⁻ is an n-valent anion, n is an integer of 1 or more, x is 0.1 to 0.4, and m is an arbitrary real number. In the above formula, M²⁺ can be an arbitrary divalent cation, and preferred examples thereof include Ni²⁺, Mg²⁺, Ca²⁺, Mn²⁺, Fe²⁺, Co²⁺, Cu²⁺, and Zn²⁺. M³⁺ can be an arbitrary trivalent cation, and preferred examples thereof include Fe³⁺, Al³⁺, Co³⁺, Cr³⁺, and In³⁺. In particular, in order for LDH to have both catalytic performance and hydroxide ion conductivity, M²⁺ and M³⁺ each are desirably a transition metal ions. From this viewpoint, more preferred M²⁺ is a divalent transition metal ion such as Ni²⁺, Mn²⁺, Fe²⁺, Co²⁺, and Cu²⁺, and particularly preferably Ni²⁺, and more preferred M³⁺ is a trivalent transition metal ion such as Fe³⁺, Co³⁺, and Cr³⁺, and particularly preferably Fe³⁺. In this case, some of M²⁺ may be replaced with a metal ion other than the transition metal, such as Mg²⁺, Ca²⁺, and Zn²⁺, and some of M³⁺ may be replaced with a metal ion other than the transition metal, such as Al³⁺ and In³⁺. Aⁿ⁻ can be an arbitrary anion. Preferred examples thereof include NO³⁻, CO₃²⁻, SO₄²⁻, OH⁻, Cl⁻, I⁻, Br⁻, and F⁻, and it is more preferably NO³⁻ and/or CO₃²⁻. Therefore, in the above formula, it is preferred that M²⁺ include Ni²⁺, M³⁺ include Fe³⁺, and Aⁿ⁻ include NO³⁻ and/or CO₃²⁻. n is an integer of 1 or more, and preferably 1 to 3. x is 0.1 to 0.4 and preferably 0.2 to 0.35. m is an arbitrary real number and more specifically greater than or equal to 0, typically a real number or an integer greater than 0 or greater than or equal to 1.

The content of the hydroxide ion conductive material contained in catalyst layer 14 is preferably the amount that allows an ion conductive path to be formed within catalyst layer. Specifically, the content is preferably 10 to 60% by volume, more preferably 20 to 50% by volume, and still more preferably 20 to 40% by volume, relative to 100% by volume of solid content of catalyst layer. The electron conductive material contained in catalyst layer is, on the other hand, preferably at least one selected from the group consisting of electron conductive ceramics and carbon-based materials. Preferred examples of the electron conductive ceramics include LaNiO₃, LaSr₃Fe₃O₁₀, and the like. Examples of the carbon-based materials include carbon black, graphite, carbon nanotubes, graphene, reduced graphene oxide, Ketjen black and arbitrary combinations thereof.

The humidity conditioning material contained in catalyst layer 14 is not particularly limited as long as it has a space capable of absorbing moisture, but is preferably in spherical, fibrous, or beltlike form. The moisture conditioning material also preferably contains a water-absorbing gel, silica gel, or both. Preferred examples of water-absorbing gels include acrylamide-based gels, polyvinyl alcohol-based gels, polyethylene oxide-based gels, cellulose-based gels, potassium polyacrylate, methyl cellulose gels, and arbitrary combinations thereof. A volume percentage of the humidity conditioning material in catalyst layer 14 is preferably 0.001 to 15% by volume, more preferably 0.01 to 15% by volume, and still more preferably 0.01 to 10% by volume when the solid content in catalyst layer 14 is 100% by volume. When the water-absorbing gel is contained as the moisture conditioning material, there is preferably a space around the gel upon drying thereof so that water is not prevented from being absorbed. In the case of providing humidity conditioning portion 20, humidity conditioning portion 20 preferably contains the moisture conditioning material described above, for example, it is preferred that a nonwoven fabric is impregnated with an aqueous solution containing the moisture conditioning material described above and used as humidity conditioning portion 20.

A known binder resin can be used as the binder contained in catalyst layer 14. Examples of the organic polymer include a butyral-based resin, vinyl alcohol-based resin, celluloses, vinyl acetal-based resin, polytetrafluoroethylene, polyvinylidene fluoride, and the like, and the butyral-based resin, polytetrafluoroethylene, and polyvinylidene fluoride are preferable.

Catalyst layer 14 can be fabricated by preparing a paste containing the hydroxide ion conductive material, the electron conductive material, the organic polymer, the humidity conditioning material, and the catalyst, and coating the surface of LDH separator 12 with the paste. Preparation of the paste can be carried out by appropriately adding the organic polymer (binder resin) and an organic solvent to a mixture of the hydroxide ion conductive material, the electron conductive material, the air electrode catalyst, and the humidity conditioning material and using a known kneader such as a three-roll mill or jet mill. Preferred examples of the organic solvent include alcohols such as butyl carbitol and terpineol, acetic acid ester-based solvents such as butyl acetate. Coating LDH separator 12 with the paste can be carried out by printing. This printing can be carried out by various known printing methods, but a screen printing is preferred.

Gas Diffusion Electrode

It is preferred that gas diffusion electrode 16 comprises a microporous layer (MPL) and a substrate for gas diffusion, and is formed on one side of catalyst layer 14 so that the microporous layer (MPL) is in contact with catalyst layer 14. The substrate for gas diffusion is not particularly limited as long as it has electron conductivity and is a porous material that can diffuse oxygen throughout the electrode, and is preferably carbon paper or a porous metallic body. A thickness of the substrate for gas diffusion is preferably 0.4 μm or less and more preferably 0.1 to 0.3 μm from the viewpoint of reducing an energy density while securing gas diffusivity. A porosity of the substrate for gas diffusion is preferably 70% or more, more preferably 70 to 90%, and particularly preferably 75 to 85% from the viewpoint of the permeation amount of the gas. The porosity values described above enable securing both excellent gas diffusibility and a wide reaction region. Moreover, the generated water is less likely to clog up pores due to the large pore spaces. The porosity can be measured by a mercury intrusion method. The microporous layer is not particularly limited as long as it has electron conductivity and water repellency to an extent that water generated by an air electrode reaction does not penetrate into the substrate for gas diffusion, and preferably contains a carbon material and polytetrafluoroethylene (PTFE).

Air Electrode Current Collector

A porous material having general electron conductivity can be used for air electrode current collector 18, which is preferably made of metal. Preferred examples of metals constituting air electrode current collector 18 include stainless steel, titanium, nickel, brass, copper and the like. A form of air electrode current collector 18 when made of metal is not particularly limited as long as its electron conductivity and air permeability are secured, but preferred examples thereof include a porous metal, metal mesh, and metal plate in uneven shape. Examples of porous metals include metallic products having open pores, such as foamed metals and sintered porous metals. Examples of metal meshes include a laminate product of metal meshes or metal mesh in laminated form. A porous metal plate such as a punching metal that has been processed into a wavy shape may be used as the metal plate in uneven shape.

As described above, air electrode/separator assembly 10 is preferably used for a metal-air secondary battery. Namely, a preferred aspect of the present invention provides a metal-air secondary battery comprising air electrode/separator assembly 10, a metal negative electrode, and an electrolyte, wherein the electrolyte is separated from catalyst layer 14 by LDH separator 12 interposed therebetween. A zinc-air secondary battery including a zinc electrode as a metal negative electrode is particularly preferred. Further, a lithium-air secondary battery including a lithium electrode as a metal negative electrode may be used.

LDH Separator According to Preferred Aspect

LDH separator 12 according to a preferred embodiment of the present invention will be described below. As described above, LDH separator 12 of the present embodiment contains a porous substrate 12a and a hydroxide ion conductive layered compound 12b which is the LDH and/or LDH-like compound, as conceptually shown in FIG. 4. In FIG. 4, the region of hydroxide ion conductive layered compound 12b is drawn so as not to be connected between the upper surface and the lower surface of LDH separator 12, but it is because the figure is drawn two-dimensionally as a cross section. When the depth thereof is three-dimensionally taken into account, the region of hydroxide ion conductive layered compound 12b is connected between the upper surface and the lower surface of LDH separator 12, whereby the hydroxide ion conductivity of LDH separator 12 is secured. Porous substrate 12a is made of a polymer material, and the pores of porous substrate 12a are clogged up with hydroxide ion conductive layered compound 12b. However, the pores of porous substrate 12a may not be completely clogged up, and residual pores P can be slightly present. By clogging up the pores of polymer porous substrate 12a with hydroxide ion conductive layered compound 12b to make the substrate highly densified in this way, LDH separator 12 capable of even more effectively inhibiting short circuits due to zinc dendrites can be provided.

Moreover, LDH separator 12 of the present embodiment has excellent flexibility and strength in addition to desirable ion conductivity required of a separator due to the hydroxide ion conductivity of hydroxide ion conductive layered compound 12b. This is due to the flexibility and strength of polymer porous substrate 12a itself contained in LDH separator 12. Namely, since LDH separator 12 is densified so that the pores of polymer porous substrate 12a are sufficiently clogged up with hydroxide ion conductive layered compound 12b, polymer porous substrate 12a and hydroxide ion conductive layered compound 12b are integrated in complete harmony as a highly composited material, and therefore the rigidity and brittleness due to hydroxide ion conductive layered compound 12b, which is a ceramic material, can be said to be offset or reduced by the flexibility and strength of polymer porous substrate 12a.

LDH separator 12 of the present embodiment desirably has extremely few residual pores P (the pores not clogged up with hydroxide ion conductive layered compound 12b). Due to residual pores P, LDH separator 12 has, for example, an average porosity of 0.03% or more and less than 1.0%, preferably 0.05% or more and 0.95% or less, more preferably 0.05% or more and 0.9% or less, still more preferably 0.05 to 0.8%, and most preferably 0.05 to 0.5%. With an average porosity within the above range, the pores of porous substrate 12a are sufficiently clogged up with hydroxide ion conductive layered compound 12b to provide an extremely high denseness, which therefore can inhibit short circuits due to zinc dendrites even more effectively. Further, significantly high ionic conductivity can be realized, and LDH separator 12 can exhibit a sufficient function as a hydroxide ion conductive dense separator. The measurement of the average porosity can be carried out by a) polishing the cross section of the LDH separator with a cross section polisher (CP), and b) using an FE-SEM (field-emission scanning electron microscope) at a magnification of 50,000× to acquire images of two fields of vision of the cross-sectional of the functional layer, and c) calculating the porosity of each of the two fields of vision by using an image inspection software (for example, HDevelop, manufactured by MVTec Software GmbH) based on the image data of the acquired cross-sectional image and determining the average value of the obtained porosities.

LDH separator 12 is a separator containing hydroxide ion conductive layered compound 12b, and separates a positive electrode plate and a negative electrode plate such that hydroxide ions can be conducted when the separator is incorporated in a zinc secondary battery. Namely LDH separator 12 exhibits a function as a hydroxide ion conductive dense separator. Therefore, LDH separator 12 has gas impermeability and/or water impermeability. Thus, LDH separator 12 is preferably densified so as to have gas impermeability and/or water impermeability. As described in Patent Literatures 2 and 3, “having gas impermeability” herein means that even when helium gas is brought into contact with one side of the object to be measured in water at a differential pressure of 0.5 atm, no bubbles are generated due to the helium gas from another surface side. Further, as used herein, “having water impermeability” means that water in contact with one side of the object to be measured does not permeate to the other side as described in Patent Literatures 2 and 3. Namely, LDH separator 12 having gas impermeability and/or water impermeability means LDH separator 12 having a high degree of denseness such that it does not allow gas or water to pass through, and means that LDH separator 12 is not a porous film or other porous material that has water permeability or gas permeability. In this way, LDH separator 12 selectively allows hydroxide ions alone to pass through due to its hydroxide ion conductivity and can exhibit a function as a battery separator. Therefore, the configuration is extremely effective in physically blocking penetration of the separator by the zinc dendrite generated upon charge to prevent a short circuit between the positive and negative electrodes. Since LDH separator 12 has hydroxide ion conductivity, it is possible to efficiently move the required hydroxide ions between the positive electrode plate and the negative electrode plate, and to realize the charge/discharge reaction in the positive electrode plate and the negative electrode plate.

LDH separator 12 preferably has a He permeability of 3.0 cm/min·atm or less per unit area, more preferably 2.0 cm/min·atm or less, and still more preferably 1.0 cm/min·atm or less. A separator having a He permeability of 3.0 cm/min·atm or less can extremely effectively inhibit Zn permeation (typically permeation of zinc ion or zinc acid ion) in an electrolyte. It is considered in principle that due to such significant inhibition of Zn penetration, the separator of the present embodiment can inhibit effectively the growth of zinc dendrite when used in a zinc secondary battery. The He permeability is measured by supplying He gas to one surface of the separator to allow the He gas to pass through the separator, and calculating the He permeability to evaluate the denseness of the hydroxide ion conductive dense separator. The He permeability is calculated by the formula of F/(P×S) by using the permeation amount F of the He gas per unit time, the differential pressure P applied to the separator when the He gas permeates, and the membrane area S through which the He gas permeates. By evaluating the gas permeability using the He gas in this way, it is possible to evaluate the presence or absence of denseness at an extremely high level, and as a result, it is possible to effectively evaluate a high degree of denseness such that substances other than hydroxide ions (in particular Zn bringing about zinc dendrite growth) can be permeated as little as possible (only a very small amount is permeated). This is because an He gas has the smallest constituent unit among a wide variety of atoms or molecules that can form a gas and also has extremely low reactivity. Namely, He constitutes a He gas by a single He atom without forming a molecule. In this respect, hydrogen gas is composed of H₂ molecules, and the He atom alone is smaller as a gas constituent unit. In the first place, H₂ gas is dangerous because it is a flammable gas. Then, by adopting the index of He gas permeability defined by the above formula, it is possible to easily evaluate the denseness objectively regardless of the difference in various sample sizes and measurement conditions. In this way, it is possible to easily, safely and effectively evaluate whether or not the separator has sufficiently high denseness suitable for a zinc secondary battery separator. The measurement of He permeability can be preferably carried out according to the procedure in Evaluation 4 of the Example described later.

In LDH separator 12, hydroxide ion conductive layered compound 12b, which is an LDH and/or LDH-like compound, clogs up the pores of porous substrate 12a. As is generally known, LDH is composed of a plurality of hydroxide basic layers and an intermediate layer interposed between the plurality of hydroxide basic layers. The basic hydroxide layer is mainly composed of metal elements (typically metal ions) and OH groups. The intermediate layer of LDH is composed of anions and H₂O. The anion is a mono- or higher-valent anion and preferably a monovalent or divalent ion. The anion in LDH preferably contains OH⁻ and/or CO₃²⁻. LDH also has excellent ion conductivity due to its unique properties.

In general, LDH has been known as a compound represented by the basic composition formula: M²⁺₁₋ₓM³⁺ₓ(OH)₂Aⁿ⁻_{x/n}·mH₂O wherein M²⁺ is a divalent cation, M³⁺ is a trivalent cation, Aⁿ⁻ is an n-valent anion, n is an integer of 1 or more, x is 0.1 to 0.4, and m is 0 or more. In the above basic composition formula, M²⁺ can be arbitrary divalent cation, but preferred examples thereof include Mg²⁺, Ca²⁺ and Zn²⁺, and it is more preferably Mg²⁺. M³⁺ can be arbitrary trivalent cation, a preferred example thereof includes Al³⁺ or Cr³⁺, and it is more preferably Al³⁺. Aⁿ⁻ can be arbitrary anion, and preferred examples thereof include OH⁻ and CO₃²⁻. Therefore, in the above basic composition formula, it is preferred that M²⁺ include Mg²⁺, M³⁺ include Al³⁺, and Aⁿ⁻ include OH⁻ and/or CO₃²⁻. n is an integer of 1 or more, and is preferably 1 or 2. x is 0.1 to 0.4 and preferably 0.2 to 0.35. m is an arbitrary numeral meaning the number of moles of water, is greater than or equal to 0, typically a real number greater than 0 or greater than or equal to 1. However, the above basic composition formula is merely a representatively exemplified formula of the “basic composition” of LDH, generally, and the constituent ions can be appropriately replaced. For example, in the above basic composition formula, some or all of M³⁺ may be replaced with a tetra- or higher-valent cation, and in that case, the coefficient x/n of anion Aⁿ⁻ in the above formula may be appropriately changed.

For example, the hydroxide basic layer of LDH may contain Ni, Al, Ti and OH groups. The intermediate layer is composed of anions and H₂O as described above. The alternating laminated structure of the hydroxide basic layer and the intermediate layer, itself is basically the same as the generally known LDH alternating laminated structure, but the LDH of the present embodiment in which the hydroxide basic layer of LDH is composed of predetermined elements or ions including Ni, Al, Ti and OH groups can exhibit excellent alkali resistance. The reason for this is not necessarily clear, but it is considered that Al, which has been conventionally thought to be easy to elute in an alkaline solution, is less likely to elute in an alkaline solution due to some interaction with Ni and Ti in the LDH of the present embodiment. Nevertheless, LDH of the present embodiment can also exhibit high ion conductivity suitable for use as a separator for an alkaline secondary battery. Ni in LDH can be in the form of nickel ions. Nickel ions in LDH are typically considered to be Ni²⁺ but are not particularly limited thereto as other valences such as Ni³⁺ are possible. Al in LDH can be in the form of aluminum ions. Aluminum ions in LDH are typically considered to be Al³⁺ but are not particularly limited thereto as other valences are possible. Ti in LDH can be in the form of titanium ions. Titanium ions in LDH are typically considered to be Ti⁴⁺ but are not particularly limited thereto as other valences such as Ti³⁺ are possible. The hydroxide basic layer may contain other elements or ions as long as it contains at least Ni, Al, Ti and OH groups. However, the hydroxide basic layer preferably contains Ni, Al, Ti and OH groups as main components. Namely, the hydroxide basic layer is preferably mainly composed of Ni, Al, Ti and OH groups. Therefore, the hydroxide basic layer is typically composed of Ni, Al, Ti, OH groups and, in some cases, unavoidable impurities. The unavoidable impurity is an arbitrary element that can be unavoidably mixed due to the production process, and can be mixed in LDH, for example, derived from a raw material or a substrate. As described above, the valences of Ni, Al and Ti are not always fixed, and it is impractical or impossible to specify LDH strictly by a general formula. Assuming that the hydroxide basic layer is mainly composed of Ni²⁺, Al³⁺, Ti⁴⁺ and OH groups, the corresponding LDH has the basic composition that can be represented by the formula: Ni²⁺_{1-x-y}Al³⁺ₓTi⁴⁺_{y}(OH)₂Aⁿ⁻_{(x+2y)/n}·mH₂O wherein Aⁿ⁻ is an n-valent anion, n is an integer of 1 or more and preferably 1 or 2, 0<x<1 and preferably 0.01≤x≤0.5, 0<y<1 and preferably 0.01≤y≤0.5, 0<x+y<1, m is 0 or more and typically a real number greater than 0 or greater than or equal to 1. However, the above formula is understood as “basic composition”, and it is understood that elements such as Ni²⁺, Al³⁺, and Ti⁴⁺ are replaceable with other elements or ions (including the same elements or ions having other valences, or elements or ions unavoidably mixed due to the production process) to an extent such that the basic characteristics of LDH are not impaired.

LDH-like compound is a hydroxide and/or oxide having a layered crystal structure like to LDH but is a compound that may not be called LDH. Preferred LDH-like compounds will be discussed below. By using an LDH-like compound that is a hydroxide and/or oxide having a layered crystal structure with the predetermined composition described below, instead of the conventional LDH, as the hydroxide ion conductive substance, a hydroxide ion conductive separator can be provided that is excellent in the alkali resistance and capable of inhibiting a short circuit due to zinc dendrite even more effectively.

As described above, LDH separator 12 contains hydroxide ion conductive layered compound 12b and porous substrate 12a (typically LDH separator 12 is composed of porous substrate 12a and hydroxide ion conductive layered compound 12b), and the hydroxide ion conductive layered compound clogs up pores of the porous substrate so that LDH separator 12 exhibits hydroxide ion conductivity and gas impermeability (hence to function as an LDH separator exhibiting hydroxide ion conductivity). Hydroxide ion conductive layered compound 12b is particularly preferably incorporated over the entire area of polymer porous substrate 12a in the thickness direction. The thickness of the LDH separator is preferably 3 to 80 μm, more preferably 3 to 60 μm, and still more preferably 3 to 40 μm.

Porous substrate 12a is made of a polymer material. Polymer porous substrate 12a has advantages of 1) having flexibility (hence, polymer porous substrate 12a hardly cracks even when it is thin), 2) facilitating increase in porosity, and 3) facilitating increase in conductivity (it can be thin while having increased porosity), and 4) facilitating manufacture and handling. Further, taking advantage derived from the flexibility of 1) above, it also has an advantage of 5) ease in bending or sealing/bonding the LDH separator containing a porous substrate made of a polymer material. Preferred examples of the polymer material include polystyrene, polyether sulfone, polypropylene, an epoxy resin, polyphenylene sulfide, a fluororesin (tetrafluororesin: PTFE, etc.), cellulose, nylon, polyethylene and any combination thereof. In view of a thermoplastic resin suitable for heat pressing, more preferred examples include polystyrene, polyether sulfone, polypropylene, an epoxy resin, polyphenylene sulfide, a fluororesin (tetrafluororesin: PTFE, etc.), nylon, polyethylene and any combination thereof. All of the various preferred materials described above have the alkali resistance, which serves as a resistance to the electrolyte of the battery. Particularly preferable polymer materials are polyolefins such as polypropylene and polyethylene and most preferably polypropylene or polyethylene in terms of excellent hot water resistance, acid resistance and alkali resistance as well low cost. When the porous substrate is made of a polymer material, the hydroxide ion conductive layered compound is particularly preferably incorporated over the entire porous substrate in the thickness direction (for example, most or almost all of the pores inside the porous substrate are filled with the hydroxide ion conductive layered compound). As such a polymer porous substrate, a commercially available polymer microporous membrane can be preferably used.

The LDH separator of the present embodiment can be produced by (i) fabricating the hydroxide ion conductive layered compound-containing composite material according to a known method (see, for example, Patent Literatures 1 to 3) by using a polymer porous substrate, and (ii) pressing this hydroxide ion conductive layered compound-containing composite material. The pressing method may be, for example, a roll press, a uniaxial pressure press, a CIP (cold isotropic pressure press), etc., and is not particularly limited. The pressing method is preferably by a roll press. This pressing is preferably carried out while heating in terms of softening the porous substrate to enable to clog up sufficiently the pores of the porous substrate with the hydroxide ion conductive layered compound. For example, for polypropylene or polyethylene, the temperature for sufficient softening is preferably heated at 60 to 200° C. Pressing by, for example, a roll press in such a temperature range can significantly reduce the average porosity derived from the residual pores of the LDH separator; as a result, the LDH separator can be extremely highly densified, and hence short circuits due to zinc dendrites can be inhibited even more effectively. When carrying out the roll pressing, the form of the residual pores can be controlled by appropriately adjusting the roll gap and the roll temperature, whereby an LDH separator having a desired denseness or average porosity can be obtained.

The method for producing the hydroxide ion conductive layered compound-containing composite material (i.e., the crude LDH separator) before pressing is not particularly limited, and it can be fabricated by appropriately changing the conditions in a known method for producing an LDH-containing functional layer and a composite material (i.e., LDH separator) (see, for example, Patent Literatures 1 to 3). For example, the hydroxide ion conductive layered compound-containing functional layer and the composite material (i.e., an LDH separator) can be produced by (1) providing a porous substrate, (2) coating the porous substrate with a titanium oxide sol or a mixed sol of alumina and titania followed by heat treatment to form a titanium oxide layer or alumina/titania layer, (3) immersing the porous substrate in a raw material aqueous solution containing nickel ions (Ni²⁺) and urea, and (4) treating hydrothermally the porous substrate in the raw material aqueous solution to form a hydroxide ion conductive layered compound-containing functional layer on the porous substrate and/or in the porous substrate. In particular, forming of the titanium oxide layer or the alumina/titania layer on the porous substrate in the above step (2) provides not only the raw material of the hydroxide ion conductive layered compound, but also the function as a starting point of the crystal growth of the hydroxide ion conductive layered compound to enable to form uniformly a highly densified hydroxide ion conductive layered compound-containing functional layer in the porous substrate. Further, the urea present in the above step (3) generates ammonia in the solution by utilizing the hydrolysis of the urea to raise the pH value, which allows the coexisting metal ions to form a hydroxide to obtain a hydroxide ion conductive layered compound. In addition, since the hydrolysis involves the generation of carbon dioxide, a hydroxide ion conductive layered compound having an anion of carbonate ion type can be obtained.

In particular, when fabricating a composite material including a porous substrate made of a polymer material in which the functional layer is incorporated over the entire porous substrate in the thickness direction (i.e., an LDH separator), the substrate is preferably coated with the mixed sol of alumina and titania in the above (2) so as to permeate the whole or most of the inside of the substrate with the mixed sol. In this way, most or almost all the pores inside the porous substrate can be finally filled with the hydroxide ion conductive layered compound. Examples of a preferable coating method include a dip coating and a filtration coating, and a dip coating is particularly preferable. By adjusting the number of times of coating by the dip coating, etc., the amount of the mixed sol adhered can be adjusted. The substrate coated with the mixed sol by dip coating, etc. may be dried and then the above steps (3) and (4) may be carried out.

LDH-Like Compounds

According to a preferred aspect of the present invention, the LDH separator can be a separator that contains an LDH-like compound. The definition of the LDH-like compound is as described above. Preferred LDH-like compounds are as follows,
(a) a hydroxide and/or oxide having a layered crystal structure containing Mg and one or more elements selected from the group consisting of Ti, Y, and Al, and containing at least Ti; or
(b) a hydroxide and/or oxide having a layered crystal structure containing (i) Ti, Y, optionally Al and/or Mg, and (ii) at least one additive element M selected from the group consisting of In, Bi, Ca, Sr and Ba, or
(c) a hydroxide and/or oxide having a layered crystal structure containing Mg, Ti, Y, optionally Al and/or In, wherein in (c), the LDH-like compound is present in a form of mixture with In(OH)₃.

According to the preferred aspect (a) of the present invention, the LDH-like compound can be a hydroxide and/or oxide having a layered crystal structure containing Mg and one or more elements selected from the group consisting of Ti, Y and Al and containing at least Ti. Thus, a typical LDH-like compound is a complex hydroxide and/or complex oxide of Mg, Ti, optionally Y and optionally Al. The above elements may be replaced with other elements or ions to an extent that the basic characteristics of the LDH-like compound are not impaired, but the LDH-like compound preferably contains no Ni. For example, the LHD-like compound may be a compound further containing Zn and/or K. In such a manner, ionic conductivity of the LDH separator can be further improved.

LDH-like compounds can be identified by X-ray diffraction. Specifically, when X-ray diffraction is carried out on the surface of the LDH separator, a peak assigned to the LDH-like compound is detected typically in the range of 5°≤2θ≤10°, and more typically in the range of 7°≤2θ≤10°. As described above, the LDH is a substance having an alternating laminated structure in which exchangeable anions and H₂O are present as an intermediate layer between the stacked hydroxide basic layers. In this regard, when LDH is analyzed by the X-ray diffraction method, a peak assigned to the crystal structure of LDH (i.e., the peak assigned to (003) of LDH) is originally detected at a position of 2θ=11 to 12°. When the LDH-like compound is analyzed by the X-ray diffraction method, on the other hand, a peak is typically detected in the aforementioned range shifted to the lower angle side than the above peak position of LDH. Further, the interlayer distance of the layered crystal structure can be determined by Bragg's equation using 2θ corresponding to the peak assigned to the LDH-like compound in X-ray diffraction. The interlayer distance of the layered crystal structure of the LDH-like compound thus determined is typically 0.883 to 1.8 nm, and more typically 0.883 to 1.3 nm.

The LDH separator by the aforementioned aspect (a) has an atomic ratio of Mg/(Mg+Ti+Y+Al) in the LDH-like compound, as determined by energy dispersive X-ray spectroscopy (EDS), which is preferably 0.03 to 0.25 and more preferably 0.05 to 0.2. Moreover, the atomic ratio of Ti/(Mg+Ti+Y+Al) in the LDH-like compound is preferably 0.40 to 0.97 and more preferably 0.47 to 0.94. Further, the atomic ratio of Y/(Mg+Ti+Y+Al) in the LDH-like compound is preferably 0 to 0.45 and more preferably 0 to 0.37. Further, the atomic ratio of Al/(Mg+Ti+Y+Al) in the LDH-like compound is preferably 0 to 0.05 and more preferably 0 to 0.03. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another preferred aspect (b) of the present invention, the LDH-like compound can be a hydroxide and/or oxide having a layered crystal structure containing (i) Ti, Y, and optionally Al and/or Mg and (ii) additive element M. Therefore, a typical LDH-like compound is a complex hydroxide and/or complex oxide of Ti, Y, additive element M, optionally Al and optionally Mg. Additive element M is In, Bi, Ca, Sr, Ba or combinations thereof. The above elements may be replaced with other elements or ions to an extent such that the basic characteristics of the LDH-like compound are not impaired, but the LDH-like compound preferably contains no Ni.

The LDH separator by the aforementioned aspect (b) has an atomic ratio of Ti/(Mg+Al+Ti+Y+M) in the LDH-like compound, as determined by energy dispersive X-ray spectroscopy (EDS), which is preferably 0.50 to 0.85 and more preferably 0.56 to 0.81. The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to 0.10 and more preferably 0 to 0.02. Then, the atomic ratio of Al/(Mg+Al+Ti+Y+M) in the LDH-like compound is preferably 0 to 0.05 and more preferably 0 to 0.04. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another further preferred aspect (c) of the present invention, the LDH-like compound can be a hydroxide and/or oxide having a layered crystal structure containing Mg, Ti, Y, and optionally Al and/or In, wherein the LDH-like compound is present in a form of mixture with In(OH)₃. The LDH-like compound in this aspect is a hydroxide and/or oxide having a layered crystal structure containing Mg, Ti, Y, and optionally Al and/or In. Therefore, a typical LDH-like compound is a complex hydroxide and/or complex oxide of Mg, Ti, Y, optionally Al and optionally In. The In that can be contained in the LDH-like compound may be not only In intentionally added to the LDH-like compound but also that unavoidably mixed into the LDH-like compound, due to formation of In(OH)₃ or the like. The above elements can be replaced with other elements or ions to an extent that the basic characteristics of the LDH-like compound are not impaired, however, the LDH-like compound preferably contains no Ni. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH.

The mixture by the above aspect (c) contains not only the LDH-like compound but also In(OH)₃ (typically composed of the LDH-like compound and In(OH)₃). In(OH)₃ contained can effectively improve alkali resistance and dendrite resistance in LDH separators. The content proportion of In(OH)₃ in the mixture is preferably the amount that can improve alkali resistance and dendrite resistance with little impairment of hydroxide ion conductivity of the LDH separator, and is not particularly limited. In(OH)₃ may have a cubic crystal structure, and have a configuration in which the crystals of In(OH)₃ are surrounded by LDH-like compounds. In(OH)₃ can be identified by X-ray diffraction.

### EXAMPLES

The present invention will be described in more detail by the following examples.

### Example 1

An air electrode/separator assembly was fabricated according to the following procedure, and evaluated.

(1) Provision of Polymer Porous Substrate

A commercially available polyethylene microporous membrane having a porosity of 50%, an average pore diameter of 0.1 μm and a thickness of 20 μm was provided as a polymer porous substrate, and cut out to a size of 3.5 cm×3.5 cm.

(2) Alumina-Titania Sol Coating on Polymer Porous Substrate

Amorphous alumina solution (Al-ML15, manufactured by Taki Chemical Co., Ltd.) and titanium oxide sol solution (M6, manufactured by Taki Chemical Co., Ltd.) were mixed in Ti/Al (molar ratio)=2 to fabricate a mixed sol. The substrate provided in (1) above was coated with the mixed sol by dip coating. The dip coating was carried out by immersing the substrate in 100 ml of the mixed sol, pulling it up vertically, and drying it in a dryer at 90° C. for 5 minutes.

(3) Preparation of Raw Material Aqueous Solution

Nickel nitrate hexahydrate (Ni(NO₃)₂·6H₂O, manufactured by Kanto Chemical Co., Inc., and urea ((NH₂)₂CO, manufactured by Sigma Aldrich Co. LLC)) were provided as raw materials. Nickel nitrate hexahydrate was weighed so as to give 0.015 mol/L and placed in a beaker, and ion-exchanged water was added thereto to make a total volume 75 ml. After stirring the obtained solution, urea weighed to satisfy the ratio of urea/NO₃⁻ (molar ratio)=16 was added in the solution, and the mixture was further stirred to obtain a raw material aqueous solution.

(4) Film Formation by Hydrothermal Treatment

The raw material aqueous solution and the dip-coated substrate were placed together in a Teflon® airtight container (autoclave container with outer stainless-steel jacket, content of 100 ml), and the container was closed tightly. At this time, the substrate was fixed while being floated from the bottom of the Teflon® airtight container and placed horizontally so that the solution was in contact with both sides of the substrate. Then, LDH was formed on the surface and the inside of the substrate by subjecting it to hydrothermal treatment at a hydrothermal temperature of 120° C. for 24 hours. With an elapse of a predetermined time, the substrate was taken out from the airtight container, washed with ion-exchanged water, and dried at 70° C. for 10 hours to form LDH in the pores of the porous substrate. In this way, a composite material containing LDH was obtained.

(5) Densification by Roll Pressing

The composite material containing LDH described above was sandwiched between a pair of PET films (Lumirror®, thickness of 40 μm, manufactured by Toray Industries, Inc.) and the roll pressing was carried out at a roll rotation speed of 3 mm/s, a roll temperature of 120° C., and a roll gap of 60 μm to obtain an LDH separator.

(6) Evaluation Result of LDH Separator

The following evaluation was carried out for the obtained LDH separator.

Evaluation 1: Identification of LDH Separator

An XRD profile was obtained by measuring the crystal phase of the LDH separator with an X-ray diffractometer (RINT TTR III manufactured by Rigaku Corporation) under the measurement conditions of voltage: 50 kV, current value: 300 mA, and measurement range: 10 to 70°. For the obtained XRD profile, identification was carried out by using the diffraction peak of LDH (hydrotalcites compound) described in JCPDS card No. 35-0964. The LDH separator of the present example was identified as LDH (hydrotalcites compound).

Evaluation 2: Measurement of Thickness

The thickness of the LDH separator was measured using a micrometer. The thicknesses were measured at three points, and the average value thereof was taken as the thickness of the LDH separator. As a result, the thickness of the LDH separator of the present example was 13 μm.

Evaluation 3: Measurement of Average Porosity

The LDH separator was cross-sectionally polished with a cross-section polisher (CP), and two fields of vision of the LDH separator cross-sectional image were acquired with a FE-SEM (ULTRA55, manufactured by Carl Zeiss) at a magnification of 50,000×. Based on this image data, porosity of each of the two fields of vision was calculated by using an image inspection software (HDevelop, manufactured by MVTec Software GmbH) and the average value thereof was taken as the average porosity of the LDH separator. As a result, the average porosity of the LDH separator of the present example was 0.8%.

Evaluation 4: Measurement of He Permeation

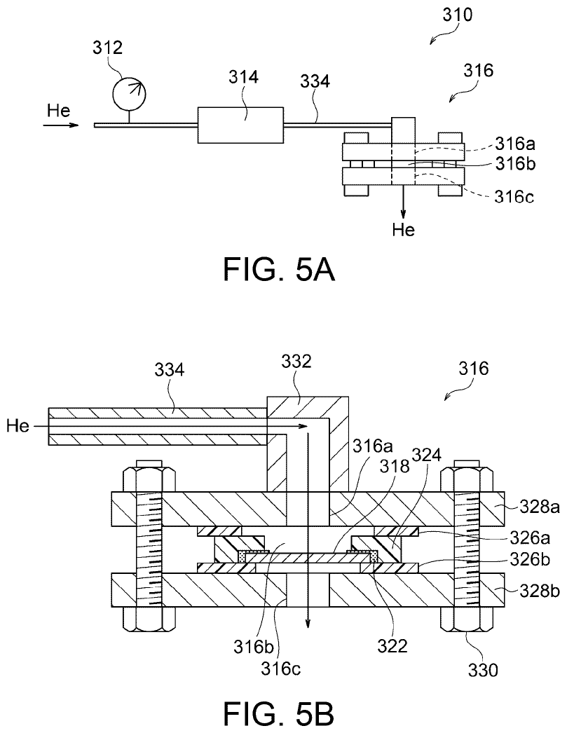

The He permeation test was carried out as follows in order to evaluate the denseness of the LDH separator in terms of He permeability. First, a He permeability measurement system 310 shown in FIGS. 5A and 5B was constructed. He permeability measurement system 310 was configured so that He gas from a gas cylinder filled with He gas was supplied to a sample holder 316 via a pressure gauge 312 and a flow meter 314 (digital flow meter) and was allowed to pass from one surface of LDH separator 318 held in sample holder 316 to the other surface to be discharged.

Sample holder 316 has a structure comprising a gas supply port 316a, a closed space 316b, and a gas discharge port 316c, and was assembled as follows. First, the outer circumference of LDH separator 318 was coated with an adhesive 322 and was attached to a jig 324 (made of ABS resin) having an opening in the center. Packings made of butyl rubber were arranged as sealing members 326a and 326b at the upper and lower ends of this jig 324 and were further sandwiched with support members 328a and 328b (made of PTFE) with openings, which were flanges, from the outside of sealing members 326a and 326b. In this way, closed space 316b was defined by LDH separator 318, jig 324, sealing member 326a, and support member 328a. Support members 328a and 328b were fastened tightly to each other by a fastening means 330 using screws so that He gas did not leak from a portion other than a gas discharge port 316c. A gas supply pipe 334 was connected to gas supply port 316a of sample holder 316 thus assembled via a joint 332.

Next, He gas was supplied to He permeability measurement system 310 through gas supply pipe 334 and was allowed to pass through LDH separator 318 held in sample holder 316. At this time, the gas supply pressure and the flow rate were monitored by pressure gauge 312 and flow meter 314. After the passage of the He gas for 1 to 30 minutes, the He permeability was calculated. The He permeability was calculated by using the formula: F/(P×S), wherein F (cm³/min) is the amount of the He gas passing per unit time, P (atm) is the differential pressure applied to the LDH separator when the He gas passes, and S (cm²) is the membrane area through which the He gas passes. The amount F (cm³/min) of He gas passing was read directly from flow meter 314. Further, differential pressure P was determined by using the gauge pressure read from pressure gauge 312. The He gas was supplied so that differential pressure P was in the range of 0.05 to 0.90 atm. As a result, the He permeability per unit area of the LDH separator was 0.0 cm/min·atm.

Evaluation 5: Observation of Microstructure of Separator Surface

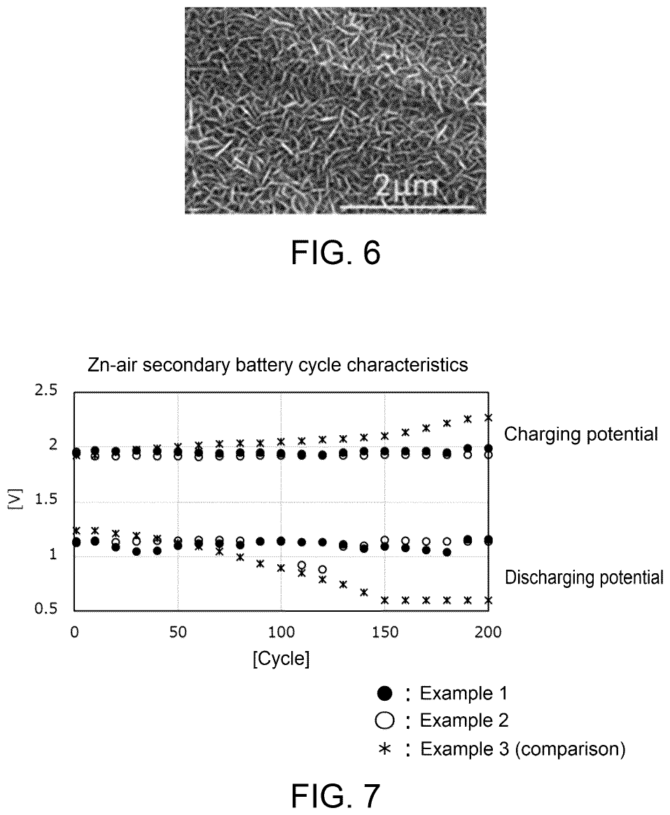

When observing the surface of the LDH separator by SEM, it was observed that innumerable LDH platy particles were bonded vertically or obliquely to the main surface of the LDH separator, as shown in FIG. 6.

(7) Fabrication of Catalyst Layer

To 16 parts by weight of carbon powder (TOKABLACK #3855, manufactured by Tokai Carbon Co., Ltd.), 23 parts by weight of LDH powder (Ni—Fe-LDH powder fabricated by a coprecipitation method) and 8 parts by weight of platinum supported carbon (EC-20-PTC, manufactured by TOYO Corporation), 5 parts by weight of a butyral resin, 19 parts by weight of a 10% by weight polyvinyl alcohol solution (a viscous solution in which 160-11485 manufactured by FUJIFILM Wako Pure Chemical Corporation was dissolved in ion-exchanged water), and 29 parts by weight of butyl carbitol were added, and the mixture was kneaded with three rolls and a planetary centrifugal mixer (ARE-310, manufactured by THINKY CORPORATION) to obtain paste. A surface of the LDH separator fabricated in (5) above was coated with this paste by screen printing to form a catalyst layer.

(8) Fabrication of Humidity Conditioning Portion

A polyvinyl alcohol (160-11485 manufactured by FUJIFILM Wako Pure Chemical Corporation) was dissolved in ion-exchanged water to make a 10% by weight aqueous solution and was impregnated into a nonwoven fabric (FT-7040P, manufactured by JAPAN VILENE COMPANY, LTD.). The impregnated nonwoven fabric was sandwiched between a pair of plates so as to be 1.5 mm thickness and then dried. The nonwoven fabric was removed from the plates and again immersed in ion-exchanged water for 1 hour, and then cut to a size (5 mm width) which was adjusted to a circumference of the electrode, with the fabric having still been absorbed water, to fabricate a humidity conditioning portion.

(9) Fabrication of Air Electrode/Separator Assembly

A gas diffusion electrode (SIGRACET29BC) was placed on the catalyst layer formed in (7) above before the paste dried, and a humidity conditioning portion was arranged in the outer circumferential portion thereof. The laminate on which a weight had been placed was dried at 80° C. for 30 minutes in air to obtain an air electrode/separator assembly as shown in FIGS. 1A to 1C.

(10) Fabrication of Zinc Oxide Negative Electrode

To 100 parts by weight of ZnO powder (manufactured by Seido Chemical Industry Co., Ltd., JIS Standard Class 1 grade, average particle size D50: 0.2 μm) were added 5 parts by weight of metallic Zn powder (manufactured by Mitsui Mining & Smelting Co., Ltd., Bi and In doped, Bi: 1000 ppm by weight, In: 1000 ppm by weight, average particle size D50: 100 μm) and further added 1.26 parts by weight of a polytetrafluoroethylene (PTFE) dispersion aqueous solution (manufactured by Daikin Industries, Ltd., solid content: 60%) in terms of solid content, and the mixture was kneaded together with propylene glycol. The resulting kneaded product was rolled by a roll press to obtain a 0.4 mm negative electrode active material sheet. The negative electrode active material sheet was then pressed onto a copper expanded metal treated with tin and then dried in a vacuum dryer at 80° C. for 14 hours. The negative electrode sheet after drying was cut out so that a portion coated with the active material has 2 cm squares, and a Cu foil was welded to the current collector portion to obtain a zinc oxide negative electrode.

(11) Thickness Measurement of Catalyst Layer

Before forming a catalyst layer, thicknesses of the LDH separator and gas diffusion electrode were measured at three locations, respectively by using a micrometer, and each average value of these thicknesses was adopted as each thickness. After the air electrode/separator assembly was fabricated, thicknesses of the air electrode/separator assembly were measured at three locations, and the thickness obtained by subtracting the thicknesses of the LDH separator and gas diffusion electrode from the average value at three locations, was adopted as a thickness of the catalyst layer. As a result, the thickness of the catalyst layer in the present example was 15 μm.

(12) Water Absorption Test of Humidity Conditioning Portion

As in (8) above, a dried body of the fabricated humidity conditioning portion was cut into 1.5 cm squares, weighed, and then immersed in ion-exchanged water for 1 hour. After 1 hour, the humidity conditioning portion was removed, placed on a KimWipe for 15 seconds for draining, and then weighed. The amount of water absorption was calculated by using the following formula, resulting in 20 g/g.

(Weight of humidity conditioning portion after water absorption [g]−Weight of humidity conditioning portion before water absorption [g])/(Weight of humidity conditioning portion before water absorption [g])

(13) Assembly and Evaluation of Evaluation Cells

A zinc oxide negative electrode was laminated on the LDH separator side of the air electrode/separator assembly. The obtained laminate was sandwiched between the holding jigs with a sealing member firmly bitten on the outer circumferential portion of the LDH separator, and the resultant was firmly fixed with screws. This holding jig had an oxygen inlet on the air electrode side and an injection port on the zinc oxide negative electrode side, through which the electrolyte was introduced. A 5.4 M KOH aqueous solution saturated with zinc oxide was added to the negative electrode side portion of the assembly thus obtained to fabricate an evaluation cell

Using an electrochemical measuring device (HZ-Pro S12 manufactured by HOKUTO DENKO CORPORATION), the charge/discharge characteristics of the evaluation cell were determined under the following conditions.
Air electrode gas: Water vapor saturation (25° C.) oxygen (flow rate of 200 cc/min)
Charge/discharge current density: 2 mA/cm²
Charge/discharge time: 60 minutes charge/60 minutes discharge
Number of cycles: 200 cycles.

The results are as shown in FIG. 7. From FIG. 7, the evaluation cell (zinc-air secondary battery) fabricated in the present Example was found to inhibit an increase in charge/discharge overvoltage even after elapsed cycles.

### Example 2

An air electrode/separator assembly as shown in FIGS. 2A and 2B was fabricated in the same manner as in Example 1 except that a humidity conditioning portion was not provided at the outer circumferential portion of the electrode, and evaluation thereof was conducted. The results are as shown in FIG. 7. It was found from FIG. 7 that evaluation cell fabricated in the present Example inhibited the increase in charge/discharge overvoltage even after elapsed cycles, compared to the cell without the humidity conditioning material in the catalyst layer.

### Example 3 (Comparison)

An air electrode/separator assembly was fabricated in the same manner as in Example 2, except that no humidity conditioning material was contained in the catalyst layer, and evaluation thereof was conducted. The results are as shown in FIG. 7. It was found from FIG. 7 that since the evaluation cell fabricated in the present Example did not contain the humidity conditioning material, an increase in charge/discharge overvoltage after elapsed cycles was large.

What is claimed is:

1. An air electrode/separator assembly, comprising:
a hydroxide ion conductive separator,
a catalyst layer comprising a catalyst for an air electrode, a hydroxide ion conductive material, an electron conductive material, a binder, and a humidity conditioning material and covering one side of the hydroxide ion conductive separator, and
a gas diffusion electrode provided on the catalyst layer on a side opposite to the hydroxide ion conductive separator.

2. The air electrode/separator assembly according to claim 1, wherein the air electrode/separator assembly further comprises a humidity conditioning portion at an outer circumferential portion of the catalyst layer, the humidity conditioning portion comprising a humidity conditioning material.

3. The air electrode/separator assembly according to claim 2, wherein the air electrode/separator assembly is arranged vertically, and wherein the humidity conditioning portion is provided at an outer circumferential portion of the catalyst layer other than the top edge thereof.

4. The air electrode/separator assembly according to claim 2, wherein the air electrode/separator assembly is arranged horizontally, and wherein the humidity conditioning portion is provided over an entire circumferential portion of the catalyst layer.

5. The air electrode/separator assembly according to claim 1, wherein the humidity conditioning material comprises a water absorbent resin.

6. The air electrode/separator assembly according to claim 5, wherein the humidity conditioning material further comprises a silica gel.

7. The air electrode/separator assembly according to claim 5, wherein the water absorbent resin is at least one selected from the group consisting of a polyacrylamide resin, potassium polyacrylate, a polyvinyl alcohol resin, and a cellulose resin.

8. The air electrode/separator assembly according to claim 1, wherein the catalyst layer comprises 0.001 to 15% by volume of the humidity conditioning material in terms of solid content, relative to 100% by volume of solid content of the catalyst layer.

9. The air electrode/separator assembly according to claim 1, wherein the catalyst layer comprises a two-layer structure composed of a catalyst layer for charge adjacent to the hydroxide ion conductive separator and a catalyst layer for discharge adjacent to the gas diffusion electrode.

10. The air electrode/separator assembly according to claim 1, wherein the hydroxide ion conductive material in the catalyst layer is a layered double hydroxide (LDH).

11. The air electrode/separator assembly according to claim 1, wherein the catalyst layer comprises 10 to 60% by volume of the hydroxide ion conductive material relative to 100% by volume of solid content of the catalyst layer.

12. The air electrode/separator assembly according to claim 1, wherein the hydroxide ion conductive separator is a layered double hydroxide (LDH) separator.

13. The air electrode/separator assembly according to claim 12, wherein the LDH separator is composited with a porous substrate.

14. The air electrode/separator assembly according to claim 1, further comprising an air electrode current collector on the gas diffusion electrode on a side opposite to the catalyst layer.

15. A metal-air secondary battery comprising the air electrode/separator assembly according to claim 1, a metal negative electrode, and an electrolyte, wherein the electrolyte is separated from the catalyst layer by the hydroxide ion conductive separator interposed therebetween.
